(19) United States
(12) Patent Application Publication
(10) Pub. No.: US 2022/0260766 A1
(43) Pub. Date: Aug. 18, 2022

(54) OPTICAL DEVICE FILM WITH TUNABLE REFRACTIVE INDEX

(71) Applicant: Applied Materials, Inc., Santa Clara, CA (US)

(72) Inventors: Kenichi OHNO, Sunnyvale, CA (US); Andrew CEBALLOS, Palo Alto, CA (US); Karl J. ARMSTRONG, Santa Clara, CA (US); Rami HOURANI, Santa Clara, CA (US); Takashi KURATOMI, San Jose, CA (US); Ludovic GODET, Sunnyvale, CA (US)

(21) Appl. No.: 17/673,538

(22) Filed: Feb. 16, 2022

Related U.S. Application Data
(60) Provisional application No. 63/150,416, filed on Feb. 17, 2021.
(60) Provisional application No. 63/301,759, filed on Jan. 21, 2022.

(51) Int. Cl. G02B 5/20; G02B 1/02

(52) U.S. Cl. CPC G02B 5/20; G02B 1/02

(57) ABSTRACT

An optical device is provided. The optical device includes an optical device substrate having a first surface; and a plurality of optical device structures disposed over the first surface of the optical device substrate, the plurality of optical device structures spaced apart from each other in a direction parallel to the first surface, and each optical device structure of the plurality of optical device structures including an optical device film. The optical device film of each optical device structure includes a first zone and a second zone, the first zone positioned between the optical device substrate and the second zone, wherein the first zone and the second zone each include one or more of oxygen and nitrogen, and the first zone and the second zone collectively include three or more metal, metalloid, or semiconductor elements.

### CROSS-REFERENCE TO RELATED APPLICATIONS

This application claims the benefit of U.S. Provisional Patent Application No. 63/150,416, filed on Feb. 17, 2021, and U.S. Provisional Patent Application No. 63/301,759, filed on Jan. 21, 2022. The contents of both of these provisional patent applications are herein incorporated by reference.

### BACKGROUND

### Field

Embodiments of the present disclosure relate to optical device films and methods of forming optical device films.

### Description of the Related Art

Virtual reality is generally considered to be a computer generated simulated environment in which a user has an apparent physical presence. A virtual reality experience can be generated in 3D and viewed with a head-mounted display (HMD), such as glasses or other wearable display devices that have near-eye display panels as lenses to display a virtual reality environment that replaces an actual environment.

Augmented reality, however, enables an experience in which a user can still see through the display lenses of the glasses or other HMD device to view the surrounding environment, yet also see images of virtual objects that are generated to appear as part of the environment. Augmented reality can include any type of input, such as audio and haptic inputs, as well as virtual images, graphics, and video that enhances or augments the environment that the user experiences. As an emerging technology, there are many challenges and design constraints with augmented reality.

One such challenge is displaying a virtual image overlaid on an ambient environment. Optical devices including waveguide combiners, such as augmented reality waveguide combiners, and flat optical devices, such as metasurfaces, are used to assist in overlaying images. Generated light is propagated through an optical device until the light exits the optical device and is overlaid on the ambient environment. As light transmits through these devices, optical loss remains a problem.

Accordingly, what is needed in the art are optical device films, methods and equipment for forming optical device films, and optical devices formed from the optical device films that reduce the problems associated with optical loss.

### SUMMARY

In one embodiment, an optical device is provided. The optical device includes an optical device substrate having a first surface; and a plurality of optical device structures disposed over the first surface of the optical device substrate, the plurality of optical device structures spaced apart from each other in a direction parallel to the first surface, and each optical device structure of the plurality of optical device structures including an optical device film. The optical device film of each optical device structure includes a first zone and a second zone, the first zone positioned between the optical device substrate and the second zone, wherein the first zone and the second zone each include one or more of oxygen and nitrogen, and the first zone and the second zone collectively include three or more metal, metalloid, or semiconductor elements.

In another embodiment, a method of forming an optical device film on an optical device substrate is provided. The method includes disposing an optical device substrate on a substrate support in a process chamber. The method further includes depositing an optical device film over the optical device substrate, wherein the optical device film comprises a first zone and a second zone, the first zone positioned between the optical device substrate and the second zone, wherein the first zone and the second zone each include one or more of oxygen and nitrogen, and the first zone and the second zone collectively include three or more metal, metalloid, or semiconductor elements.

In another embodiment, a method of forming an optical device film on an optical device substrate is provided. The method includes disposing an optical device substrate on a substrate support in a first process chamber. The method further includes depositing a first zone of the optical device film over the optical device substrate, wherein the first zone of the optical device film comprises: one or more of oxygen and nitrogen, and two or more metal, metalloid, or semiconductor elements; disposing an optical device substrate on a substrate support in a second process chamber. The method further includes depositing a second zone of the optical device film over the first zone of the optical device film, wherein the second zone of the optical device film comprises: one or more of oxygen and nitrogen, and two or more metal, metalloid, or semiconductor elements, wherein the two or more metal, metalloid, or semiconductor elements included in the second zone are different than the two or more metal, metalloid, or semiconductor elements included in the second zone.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 is a schematic, cross-sectional view of an optical device film according to embodiments described herein.

FIG. 2A and FIG. 2B are schematic, cross-sectional views of optical devices formed from the optical device film of FIG. 1 according to embodiments described herein.

FIG. 3A is a schematic, cross-sectional view of a physical vapor deposition (PVD) chamber according to embodiments described herein.

FIG. 3B is a schematic top view of a cluster tool, according to one embodiment.

FIG. 4 is a schematic, cross-sectional view of a chemical vapor deposition (CVD) chamber according to embodiments described herein.

FIGS. 5 and 6 are flow diagrams of methods for forming an optical device film according to embodiments described herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure relate to optical devices including optical device films and methods of forming the optical device films of the optical devices. Specifically, embodiments described herein provide for optical devices including optical device films that are formed of three or more materials, such as three or more elements from the Periodic Table of Elements. The three or more elements in the optical device film can include (1) at least two elements classified as a metal, a metalloid, or semiconductor element, and (2) at least one of oxygen and nitrogen. In some embodiments, another non-metallic element is used instead of oxygen or nitrogen, such as carbon.

A non-limiting list of different metal, metalloid, and semiconductor elements are provided below. Although many of the embodiments of optical device films described herein are described as including only three elements (e.g, Si, Ti, and O), the optical device films can include three or more (e.g., 5-10) different metal, metalloid, or semiconductor elements as well as both oxygen and nitrogen (e.g., an oxynitride material) at the same locations in an optical device film or at different locations in an optical device film. Including more elements (e.g., more than three) in an optical device film can assist in forming a film that has a varying refractive index across the thickness of the film in which the refractive index can (1) span a larger range than if only three elements were included in the optical device film, or (2) span a range of refractive indexes that results in less optical loss when compared to spanning the same range with only three elements.

In some embodiments, the optical device films include layers with different materials, such as different element that are not included in other layers. In other embodiments, the optical device film includes changing relative concentrations of the same materials, such as a film in which a relative concentration of titanium and silicon change throughout a thickness of an optical device film formed of titanium, silicon, and oxygen. Used herein, unless otherwise noted, relative concentration refers to a relative concentration of an element (e.g., Ti) at a particular location in the optical device film compared to one or more other elements at that particular location in the optical device film, where the relative concentration is determined without reference to a concentration of oxygen or nitrogen. For example, for a layer including titanium, silicon, and oxygen, a relative concentration of 25% silicon at a particular location means that the particular location has a relative concentration that is 25% silicon out of a total amount of silicon and titanium regardless of the concentration of oxygen. Thus, for a layer including three elements (e.g., Si, Ti, and O) where one of the elements is oxygen or nitrogen, then the relative concentrations of the two elements that are not oxygen or nitrogen can be expressed as X and 1−X. For example, a relative concentration of 25% silicon (i.e., X) at a particular location in a layer that includes silicon, titanium, and oxygen means that the relative concentration of titanium is 75% (i.e., 1−X) at that location.

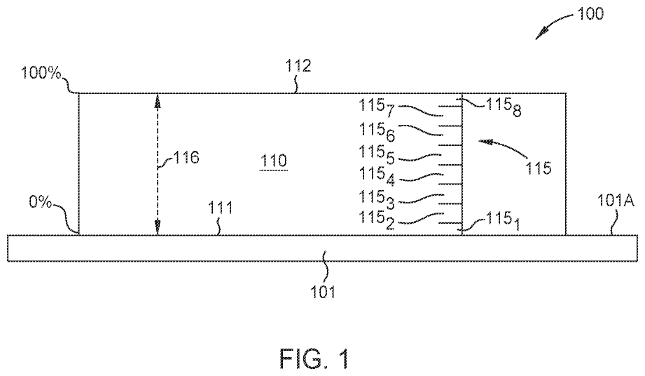

FIG. 1 is a schematic, cross-sectional view of an optical device 100, according to one embodiment. The optical device 100 includes an optical device film 110 disposed on an optical device substrate 101.

The optical device substrate 101 includes a first surface 101A (top surface). The optical device film 110 is formed over the first surface 101A of the optical device substrate 101. The optical device substrate 101 is any suitable optical device substrate on which an optical device may be formed. In one embodiment, the optical device substrate 101 is a silicon (Si) containing optical device substrate. In one embodiment, the optical device substrate 101 is a glass substrate, such as a silicon oxide-based glass, a metal oxide-based glass, or a high refractive index glass substrate (e.g, a glass substrate with a refractive index greater than 2.0). In some embodiments, the optical device substrate 101 includes, but is not limited to, silicon (Si), silicon nitride (SiN), silicon dioxide (SiO₂), fused silica, quartz, silicon carbide (SiC), germanium (Ge), silicon germanium (SiGe), indium phosphide (InP), gallium arsenide (GaAs), gallium oxide (GaO), lanthanum oxide (LaO), magnesium oxide (MgO), diamond, lithium niobate (LiNbO₃), gallium nitride (GaN), sapphire, tantalum oxide (Ta₂O₅), titanium dioxide (TiO₂), or combinations thereof. In some embodiments, the optical device substrate 101 may include a perovskite material that is optically transparent. In another embodiment, the optical device substrate 101 is a layered optical device substrate, for example a thin glass bonded to a silicon carrier. The layered optical device substrate may be a substrate with optical device stacks disposed on the substrate (e.g., patterned optical device films for gratings, waveguides, optoelectronics, monolithically-integrated CMOS-photonic device, heterogeneously-integrated CMOS-photonic devices). In yet another embodiment, the optical device substrate 101 is a laminated substrate comprising multiple layers of bonded glass. More generally, the optical device substrate 101 can be formed from any suitable material, provided that the substrate can adequately transmit light in a desired wavelength or wavelength range and can serve as an adequate support for the plurality of optical device films.

The optical device film 110 is an oxide and/or nitride optical device film that further includes two or more, such as three or more, metal, metalloid, or semiconductor elements. Generally any element classified as a metal, metalloid, or semiconductor element that can be used to form an optical device film can be used to obtain the benefits of this disclosure. That said, some specific non-limiting examples of metal, metalloid, or semiconductor elements that can benefit from this disclosure include titanium (Ti), silicon (Si), niobium (Nb), tantalum (Ta), aluminum (Al), indium (In), chromium (Cr), ruthenium (Ru), hafnium (Hf), magnesium (Mg), zirconium (Zr), vanadium (V), molybdenum (Mo), tungsten (W), manganese (Mn), iron (Fe), cobalt (Co), nickel (Ni), copper (Cu), zinc (Zn), gallium (Ga), tin (Sn), bismuth (Bi), antimony (Sb), gadolinium (Gd), praseodymium (Pr), scandium (Sc), and yttrium (Y).

The optical device film 110 has a first surface 111 and a second surface 112. The first surface 111 can be formed over (e.g., directly on) the optical device substrate 101. The first surface 111 may also be referred to as a bottom surface. The second surface 112 is an opposing surface to the first surface 111. The second surface 112 may also be referred to as a top surface. The second surface 112 is spaced apart from the first surface 111 by a thickness 116.

The thickness 116 of the optical device film 110 is divided into a range of zones 115. Each individual zone 115n is identified by a subscript, where the subscript is an integer identifying the location of the zone 115 relative to the first surface 111 (bottom surface) that is formed over the optical device substrate 101. For example, the optical device film 110 includes eight zones 115₁₋₈ with the first zone being 115₁ and the eight zone being 115₈. The first zone 115₁ is disposed between the second zone 115₂ and the optical device substrate 101.

In some embodiments, the first zone 115₁ can be formed to have a refractive index that is equal to or substantially close to (e.g., within 0.02) the refractive index of the optical device substrate 101. For example, in one embodiment, a layer of TiSiO can be formed to have a refractive index of 2.0 to be matched with a glass optical device substrate having a refractive index of 2.0. Having the refractive index of the first zone 115₁ formed on top of the substrate 101 be the same or substantially the same as the refractive index of the substrate 101 can help reduce light scattering and optical loss that can occur as a result of light passing through the two materials (i.e., the substrate 101 and the first zone 115₁).

Although eight zones 115 are shown, embodiments can include more or less zones 115. Each zone 115 includes (1) at least one of oxygen and nitrogen, and (2) at least one metal, metalloid, or semiconductor element. That said individual zones 115 can include oxygen and nitrogen and/or two or more metal, metalloid, or semiconductor elements, such as four metal, metalloid, or semiconductor elements at a same location across the thickness 116 of the optical device film 110.

In different optical device films 110, the zones 115 can represent different things. For example, in some embodiments, the different zones 115 can represent different layers that include different materials (e.g., different elements). In other embodiments, the zones 115 represent different relative concentrations of the same materials, such as different relative concentrations of silicon and titanium in a layer that includes silicon, titanium, and oxygen. Generally, each pair of zones 115 that share a border generally have a different refractive index although this is not required. In some embodiments, zones 115 that are spaced apart from each other can have a same refractive index.

In one embodiment, which can be combined with other embodiments described herein, the thickness 116 can have a constant or substantially constant oxygen or nitrogen concentration throughout the range of zones 115 of the optical device film 110. In one embodiment, the difference in oxygen or nitrogen concentration between each zone 115 of range of zones 105 is an atomic percentage of 10% (e.g., plus or minus 5%). In one embodiment, the oxygen concentration of an optical device film 110 of a first material of TiO₂ and a second material of SiO₂ is about 66.67 atomic percent at plus or minus 10%.

In FIG. 1, each zone 115 is shown having a same thickness, but this is not required as one or more of the zones 115 may have a different thickness than the other zones 115. In some embodiments, each individual zone 115ₙ has a zone thickness of about 0.001% to about 99.999% of the total thickness 116, such as from about 1% to about 50% of the total thickness 116. In one embodiment, one or more of the zones 115n in the optical device film 110 can be formed of a different material, such as including a different element that is not included in one or more of the other zones 115ₙ. For example, in one embodiment, the first zone 115₁ can be formed titanium, silicon, and oxygen while the eighth zone 115₈ can be formed of titanium, niobium, and nitrogen. In another embodiment, each zone 115 can include a substantially different relative concentration of two or more elements (e.g., titanium and silicon). For example, in one embodiment, the first zone 115₁ can be formed of titanium, silicon, and oxygen while the second zone 115₂ can also be formed of titanium, silicon, and oxygen with (1) the relative concentration of titanium being higher in the first zone 115₁ than the second zone 115₂ and (2) the relative concentration of silicon being higher in the second zone 115₂ than the first zone 115₁. In another embodiment, the relative concentrations of two or more of the elements gradually change across individual zones 115ₙ, so that there is not a significant step change in the relative concentrations of the elements at the border between two individual zones 115ₙ.

Forming the zones 115 to have different relative concentrations of different elements (e.g., Ti and Si) across the thickness 116 of the optical device film 110 allows for the modification of the optical properties (e.g., refractive index), of the optical device film 110.

In some embodiments, the relative concentration of a first element (e.g., Ti) can have a first concentration profile through the range of zones 115 of the thickness 116, and a second element (e.g., Si) can have a second concentration profile through the range of zones 115 of the thickness 116. In one of these embodiments, the first element can have a maximum relative concentration at the first zone 115₁ and a minimum relative concentration at the top eight zone 115₈. Although not required, in some embodiments, the minimum relative concentration can be 0% and the maximum relative concentration can be 100%. Conversely, the second element can have a minimum relative concentration at the first zone 115₁ and a maximum relative concentration at the top eight zone 115₈. In some embodiments that include oxygen, the oxygen concentration can be about 66.67 atomic percent plus or minus 10% (e.g., of a first material of TiO₂ and a second material of SiO₂). Across the zones 115, the concentrations of the silicon and titanium can vary from a minimum concentration of about 0 atomic percent and a maximum concentration of about 33.3 atomic percent.

In another embodiment, the first element (e.g., Ti) has a minimum relative concentration at the first zone 115₁ and a maximum concentration at the eighth zone 115₈. Conversely, the second element (e.g., Si) has a maximum concentration at the first zone 115₁ and a minimum concentration at the eighth zone 115₈. In this embodiment, the relative concentrations of the first element and/or the second element can increase or decrease for each successive individual zone 115ₙ of the zones 115 as the relative concentration of the elements goes from minimum to maximum (i.e., first element) or maximum to minimum (i.e., second element). This increase or decrease in the relative concentrations can include gradual changes within the individual zones 115ₙ or only include step-changes in relative concentrations between the different zones 115. For embodiments including gradual changes in the relative concentrations, the gradual changes can span the entire thickness 116 of the optical device film 110, so that there is a continuous gradual change in the refractive index across the thickness 116 of the optical device film 110.

In some embodiments, the relative concentrations of the first element (e.g., Ti) and the second element (e.g., Si) can follow sinusoidal profiles across the range of zones 115. In one of these embodiments, the first element can have a relative concentration that (1) has a maximum at the first zone 115₁, (2) decreases to a minimum concentration at a midpoint of the range of zones 115, and (3) increases back to the maximum concentration at the final zone 115₈. Conversely, the second element can have a relative concentration that (1) has a minimum concentration at the first zone 115₁, (2) increases to a maximum concentration at a midpoint of the range of zones 115 and (3) decreases back to the minimum concentration at the final zone 115₈. These sinusoidal profiles can follow a gradual change in the relative concentrations within the individual zones 115ₙ or the sinusoidal profiles can include a step change between each pair of neighboring zones 115 with the relative concentrations staying constant within the individual zones 115ₙ.

The following provides some additional non-limiting examples of some different embodiments of optical device films 110. In one embodiment, the optical device film 110 is formed of a single ternary material (e.g., TixSi₁₋ₓO), where the relative concentration of titanium and silicon change for each zone 115 in a bordering pair of zones 115 in the optical device film 110. In the formula TiₓSi₁₋ₓO, x can range from zero to one, x is the relative concentration of titanium and 1−x is the relative concentration of silicon such that x and 1−x always add up to one. In some of these embodiments, the relative concentrations are constant throughout the thickness of the individual zones 115, but vary between the zones 115, so that the refractive index varies between the zones 115. In some embodiments, two zones that are spaced apart from each other can have the same relative concentrations and the same refractive index, such as the second zone 115₂ and the sixth zone 115₆.

In other of these embodiments, the relative concentrations vary gradually across the zones 1115, so that the refractive index varies gradually across the zones 115. Gradual adjustments of the refractive index across the different zones 115 can help to reduce light scattering and optical loss. In some of these embodiments, the relative concentrations of titanium and oxygen can be the same or substantially the same at the border between the zones 115. For example, the top of the first zone 1151 can have the same or substantially the same relative concentrations of titanium and silicon as the bottom the second zone 115, so that there is little to no change in the refractive index at the border between the bordering zones 115.

Some embodiments of the optical device film can include three or more different metal, metalloid, or semiconductor elements in a single zone 115 or collectively across multiple zones 115. For example, in one embodiment, the three or more metals, metalloids, and semiconductor elements collectively include silicon and titanium in the first zone 115₁ and niobium in another zone, such as the second zone 115₂.

In another embodiment, the first zone 115₁ includes two or more metal, metalloid, or semiconductor elements (e.g., Ti and Si), and another zone 115 (e.g., the eighth zone 115₈ includes two or more metal, metalloid, or semiconductor elements (e.g., Nb and Ta) that are different than the two or more metal, metalloid, or semiconductor elements in first zone 115₁. In a variation of this embodiment, another zone 115 that is between the two other zones 115, such as the fifth zone 115₅, can include a fifth metal, metalloid, or semiconductor element that is not included in the other zones 115, such as chromium.

In another embodiment, the first zone 115₁ includes two or more metal, metalloid, or semiconductor elements (e.g., Ti and Si), and another zone 115 (e.g., the eighth zone 115₈ includes two or more metal, metalloid, or semiconductor elements (e.g., Ti and Nb), so that one metal, metalloid, or semiconductor element included in the first zone 115₁ is a same element as one metal, metalloid, or semiconductor element included in the eighth zone 115₈, and one metal, metalloid, or semiconductor element included in the first zone 115₁ is different than one metal, metalloid, or semiconductor element included in the eighth zone 115₈. In a variation of this embodiment, another zone 115 that is between the two other zones 115, such as the fifth zone 115₅, can include a fourth metal, metalloid, or semiconductor element that is not included in the other zones 115, such as chromium.

In another embodiment, the first zone 115₁ includes titanium, silicon, and oxygen, the third zone 115₃ includes titanium, niobium, and oxygen, and the second zone 115₂ includes only silicon and oxygen (i.e., a binary material layer). Other embodiments can include (1) at least two zones 115 formed of ternary materials (e.g., TiSiO) that include two metal, metalloid, or semiconductor elements along with oxygen or nitrogen, and (2) at least two at least two zones 115 formed of binary materials (e.g., TiO or SiO) that include only one metal, metalloid, or semiconductor element along with oxygen or nitrogen. Another embodiment can include (1) one zone 115 formed of a binary material that includes only one metal, metalloid, or semiconductor element along with oxygen or nitrogen, and (2) at least two zones 115 formed of ternary materials that include two metal, metalloid, or semiconductor elements along with oxygen or nitrogen. Another embodiment can include at least three different zones 115 that each include formed of ternary materials that include two or more metal, metalloid, or semiconductor elements along with oxygen or nitrogen, where the two or more metal, metalloid, or semiconductor elements are different for each of the three zones (e.g., three zones 115 that include six different metal elements with each zone 115 including two of the six metal elements).

In one embodiment, the zones 115 can be an alternating stack of binary materials (e.g., TiO and SiO). In one of these embodiments, each individual zone 115ₙ has a thickness (i.e., a thickness in the same direction as thickness 116) of less than 1 nm. In some of these embodiments, the process conditions (e.g., RF power, DC bias, DC power to one or more of the cathodes, temperature, pressure and gas flows), can be varied to make small adjustments to the refractive index of the different zones being deposited.

In some embodiments, one or more of the zones 115 can be formed of an oxynitride material that includes one or more metal, metalloid, or semiconductor elements, such as SiON.

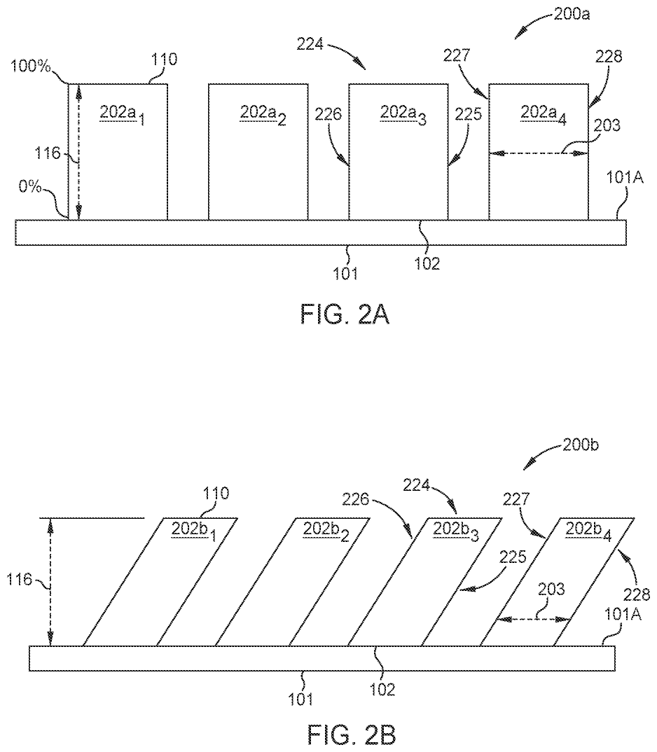

FIG. 2A and FIG. 2B are schematic, cross-sectional views of two different optical devices 200a,200b that can be formed from the optical device film 110 in the optical device 100 shown in FIG. 1. The optical devices 200a, 200b include respective optical device structures 202a, 202b disposed over the first surface 101A of the optical device substrate 101. The plurality of optical device structures 202a, 202b spaced apart from each other in a direction parallel to the first surface 101A of the optical device substrate 101.

The optical device structures 202a, 202b include sub-micron critical dimensions, e.g., nanosized dimensions, corresponding to the widths 203 of the optical device structures 202a, 202b. The optical devices 200a, 200b shown in FIGS. 2A, 2B can form part of a waveguide combiner, a flat optical device (e.g., a metasurface), or another optical device.

In the optical device 200a shown in FIG. 2A, the optical device structures 202a may be binary structures with a top surface 224 of the optical device structures 202a parallel to a top surface 102 of the optical device substrate 101. Furthermore, in some embodiments the sidewalls of the different optical device structures 220a can be parallel to each other. For example, FIG. 2A shows a first sidewall 225 and a second sidewall 226 of a third optical device structure 220a3 parallel to a third sidewall 227 and a fourth sidewall 228 of a fourth optical device structure 202a4. Additionally, the sidewalls 225, 226, 227, and 228 can be oriented normal to the top surface 102 of the optical device substrate 101.

In the optical device 200b shown in FIG. 2B, the optical device structures 202b may be angled structures. The angled structures 202b can include sidewalls that are slanted relative to the top surface 102 of the optical device substrate 101. For example, FIG. 2B shows sidewalls 225, 226 of a third optical device structure 202b3 and sidewalls 227, 228 of a fourth optical device structure 202b4 slanted relative to the top surface 102 of the optical device substrate 101.

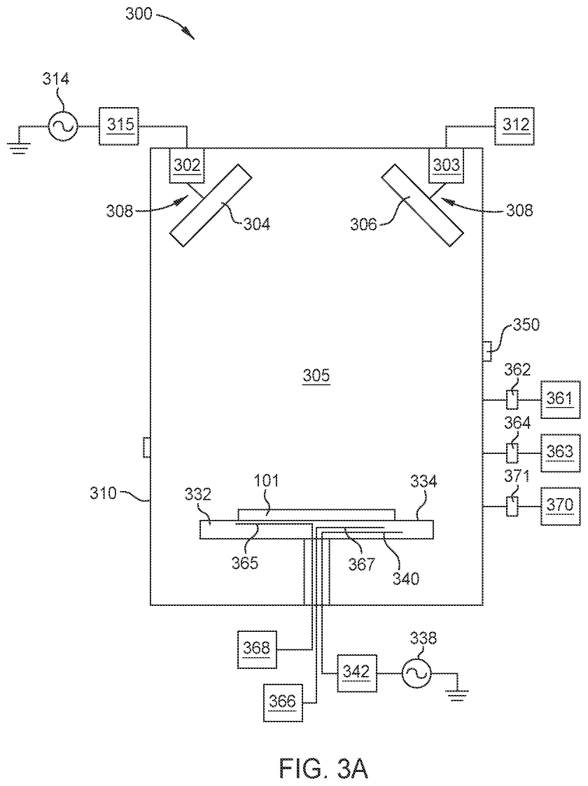

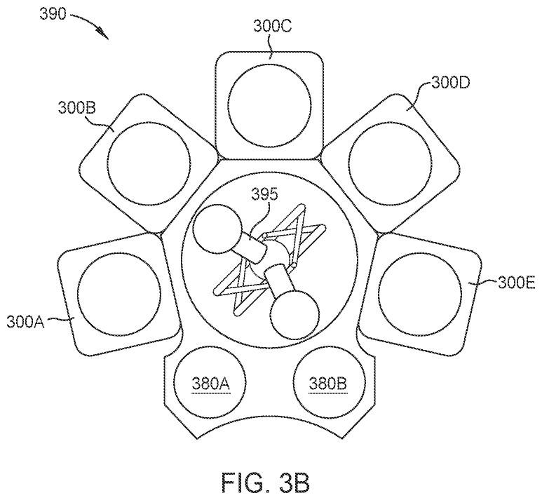

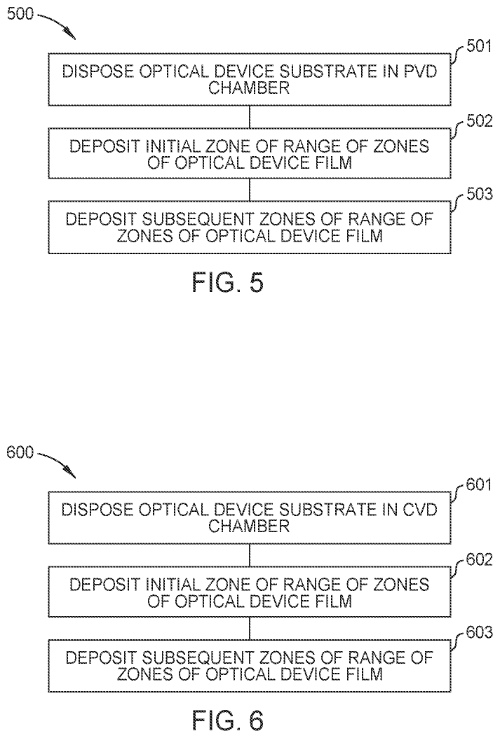

FIG. 3A is a schematic, cross-sectional view of a physical vapor deposition (PVD) chamber 300. The PVD chamber 300 may be used to perform the PVD methods described below, such as the methods described in reference to FIGS. 5 and 6. It is to be understood that the PVD chamber 300 described below is an exemplary PVD chamber and other PVD chambers may be used with or modified to accomplish aspects of the present disclosure.

The PVD chamber 300 includes a chamber body 310 that encloses a process volume 305. The PVD chamber 300 further includes a substrate support 332 disposed in the process volume 305. The substrate support 332 includes a support surface 334 that can be used to support a substrate during a process, such as the optical device substrate 101 from FIG. 1.

The PVD chamber 300 further includes a plurality of cathodes including a first cathode 302 and a second cathode 303. The PVD chamber 300 additionally includes a plurality of targets including a first target 304 and a second target 306. Each cathode 302, 303 can be attached (e.g., mounted) to the chamber body 310. The first target 304 and the second target 306 can each be attached to the corresponding first cathode 302 and second cathode 303 through a chamber body adapter 308. The chamber body adapter 308 can be used to mechanically and electrically connect the targets 304, 306 to the corresponding cathodes 302, 303. The first target 304 includes a first material, such as a first element (e.g., silicon). The second target 306 includes a second material, such as a second element (e.g., titanium). Each cathode 302, 303 can be coupled to a DC power source 312 or to an RF power source 314 and matching network 315, so that DC power or RF power can be coupled to the targets 304, 306 during processing.

Although only two cathode and targets are shown, in some embodiments, the PVD chamber can include three or more (e.g., 5-10) targets and corresponding cathodes, with each target formed of a different material, such as a different element. These additional targets can allow a larger variety of layers to be deposited on a single optical device film as well as on different optical device films. Often, two or more of the targets can be co-sputtered during a deposition, so that multiple elements are deposited at the same location within the optical device film 110. For example, a silicon target and a titanium target can be co-sputtered while oxygen is provided to the process volume 305 to deposit an optical device film 110 of a ternary material that includes titanium, silicon, and oxygen.

The PVD chamber 300 further includes an opening 350 (e.g., a slit valve) through which an end effector (not shown) can extend to place an optical device substrate 101 onto lift pins (not shown) for lowering the optical device substrate 101 onto the support surface 334 of the substrate support 332.

The PVD chamber 300 includes a sputter gas source 361 operable to supply a sputter gas, such as argon (Ar) to the process volume 305. A gas flow controller 362 is disposed between the sputter gas source 361 and the process volume 305 to control a flow of the sputter gas from the sputter gas source 361 to the process volume 305. The PVD chamber 300 further includes a reactive gas source 363 operable to supply a reactive gas, such as an oxygen-containing gas or nitrogen-containing gas to the process volume 305. A gas flow controller 364 is disposed between the reactive gas source 363 and the process volume 305 to control a flow of the reactive gas from the reactive gas source 363 to the process volume 305. The PVD chamber 300 may further include a precursor gas source 370 operable to supply a precursor gas to the process volume 305. A gas flow controller 371 is disposed between the precursor gas source 370 and the process volume 305 to control a flow of the precursor gas from the precursor gas source 370 to the process volume 305.

The substrate support 332 includes a bias electrode 340. An RF bias power source 338 coupled to the bias electrode 340 disposed in the substrate support 332 via a matching network 342. The substrate support 332 can include a mechanism (not shown) that retains the optical device substrate 101 on the support surface 334 of the substrate support 332, such as an electrostatic chuck, a vacuum chuck, a substrate retaining clamp, or the like. The substrate support 332 can further include a cooling conduit 365 disposed in the substrate support 332. The cooling conduit 365 can be used to controllably cool the substrate support 332 and the optical device substrate 101 positioned thereon to a predetermined temperature. The cooling conduit 365 is coupled to a cooling fluid source 368 to provide cooling fluid (not shown). The substrate support 332 can further include a heater 367 embedded therein. The heater 367 (e.g., a resistive element), disposed in the substrate support 332 can be coupled to a heater power source 366. The heater 367 can be used to controllably heat the substrate support 332 and the optical device substrate 101 positioned thereon to a predetermined temperature.

While FIG. 3A depicts a first cathode 302 coupled to a first target 304 and a second cathode 303 coupled to a second target 306, the PVD chamber 300 may include additional cathodes and targets. In embodiments including additional targets, each target can be formed of a different material (e.g., a different element) enabling a variety of materials to be formed in the different zones 115 (see FIG. 1) of the optical device film 110.

FIG. 3B is a schematic top view of a cluster tool 390, according to one embodiment of the disclosure. The cluster tool 390 includes five physical vapor deposition (PVD) chambers 300A-E. Each PVD chamber 300A-E can be the same as the PVD chamber 300 described above in reference FIG. 3A. The cluster tool 390 further includes two transfer chambers 380A, 380B for transferring optical device substrates 101 into and out of the cluster tool 390. The cluster tool 390 further includes a transfer robot 395 for moving the optical device substrates 101 between the different PVD chambers 300A-E and into and out of the transfer chambers 380A, 380B.

In some embodiments, one or more of the PVD chambers 300A-E in the cluster tool 390 include one or more different target materials, so that different materials can be deposited in the different PVD chambers 300. For example, in one embodiment, the first PVD chamber 300A can include a silicon material for the first target 304 and a titanium material for the second target 306 while the fifth PVD chamber 300E can include a tantalum material for the first target 304 and a niobium material for the second target 306. Thus, using this example, the first PVD chamber 300A can be used to deposit a first zone 1151 including titanium and silicon along with oxygen and/or nitrogen, while the fifth PVD chamber 300E can be used to deposit another zone (e.g., the eighth zone 1158) including tantalum and niobium along with oxygen and/or nitrogen.

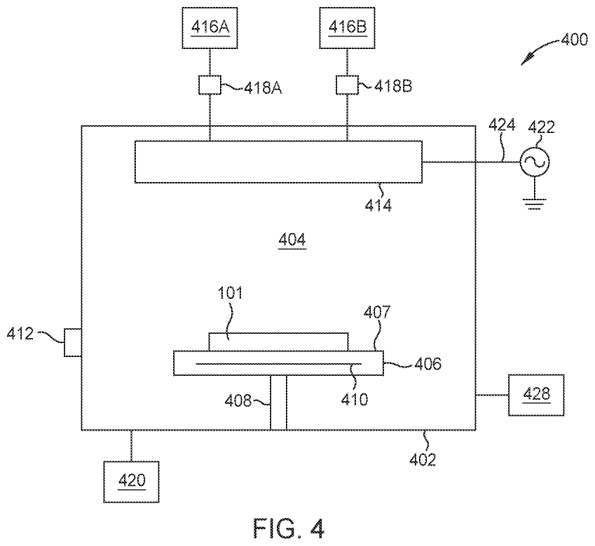

FIG. 4 is a schematic, cross-sectional view of a chemical vapor deposition (CVD) chamber 400 that may be used to perform the method 700 described below in reference to FIG. 7. It is to be understood that the CVD chamber 400 described herein is an exemplary CVD chamber and other CVD chambers may be used with or modified to accomplish aspects of the present disclosure.

The CVD chamber 400 includes a chamber body 402 that encloses a processing volume 404. The CVD chamber 400 further includes a substrate support 406 disposed in the process volume 404. The substrate support 406 includes a support surface 407 that can be used to support a substrate during a process, such as the optical device substrate 101 from FIG. 1.

The substrate support 406 further includes a heating/cooling conduit 410 and a mechanism (not shown) that can retain the optical device substrate 101 on the support surface 407 of the substrate support 406, such as an electrostatic chuck, a vacuum chuck, a substrate retaining clamp, or the like. The substrate support 406 is coupled to and movably disposed in the processing volume 404 by a stem 408 connected to a lift system (not shown) that moves the substrate support 406 between an elevated processing position and a lowered position that facilitates transfer of the optical device substrate 101 to and from the CVD chamber 400 through an opening 412.

The CVD chamber 400 further includes a showerhead 414, a first gas source 416A, a second gas source 4166, a first flow controller 418A, and a second flow controller 418B. The first flow controller 418A is disposed between the first gas source 416A and the chamber body 402 to control a first flow rate of a first process gas from the first gas source 416A to the showerhead 414. The second flow controller 418B is disposed between the second gas source 416B and the chamber body 402 to control a second flow rate of a second process gas from the second gas source 416B to the showerhead 414. The showerhead 414 is connected to an RF power source 422 by an RF feed 424 for generating a plasma in the processing volume 404 from the first process gas and/or the second process gas. The RF power source 422 provides RF energy to the showerhead 414 to facilitate generation of a plasma between the showerhead 414 and the substrate support 406. A vacuum pump 420 is coupled to the chamber body 402 for controlling the pressure within the processing volume 404. A controller 428 is coupled to the CVD chamber 400 and configured to control aspects of the CVD chamber 400 during processing.

While FIG. 4 depicts a first gas source 416A and a second gas source 416B, the CVD chamber 400 may include one or more additional gas sources, for example to provide other process gases the processing volume 404 during a deposition. For example, 3-5 gas sources may be included in the CVD chamber 400. In embodiments with three or more gas sources, each gas source can be used to deposit a different material (e.g., element, such as silicon, oxygen, etc.).

FIG. 5 is a flow diagram of a method 500 of forming the optical device film 110 shown in FIG. 1, according to one embodiment. The optical device film 110 may be modified in subsequent processes to form the devices 200a (FIG. 2A), 200b (FIG. 2B). The method 500 can be performed using the PVD chamber 300 of FIG. 3A. However, it is to be noted that a PVD chamber other than the PVD chamber 300 of FIG. 3A may be used to perform the method 500.

The method 500 begins at operation 501. The method 500 is described as being performed using the PVD chamber 300 from FIG. 3A, but the method 500 can also be performed using the PVD chambers 300A-300E in the cluster tool 390 shown in FIG. 3B as well as with other PVD chambers (not shown). At operation 501, the optical device substrate 101 is disposed on the substrate support 332 in the PVD chamber 300.

At operation 502, the first zone 115₁ of the range of zones 115 of the optical device film 110 is deposited. The first target 304 having a first element (e.g., silicon) is set to a first power level, and the second target 306 having a second element (e.g., titanium) is set to a second power level. A sputter gas (e.g., argon) can be provided to the process volume 305 from sputter gas source 361 to sputter the targets 304, 306. Having the refractive index of the first zone 115₁ be equal to or substantially close to the refractive index of the optical device substrate 101 can help limit optical loss that can occur as light passes across the boundary between the optical device substrate 101 and the first zone 115₁.

In one embodiment, the first material of the first target 304 and/or the second material of the second target 306 can include an oxygen-containing material or a nitrogen-containing material. In another embodiment, an oxygen-containing gas or a nitrogen-containing gas is supplied to the process volume 305, for example from reactive gas source 363. In the embodiment, the first element from the first target 304 and the second element from the second target 306 react with the oxygen-containing gas or nitrogen-containing gas to form the first zone 115₁ of the optical device film 110.

In one embodiment, a relative concentration of the first element (e.g., Si) from the first target 304 has a maximum concentration in the first zone 115₁ of the range of zones 115 by applying a high power level to the first target 304. In the embodiment, a relative concentration of the second element (e.g., Ti) from the second target has a minimum concentration at the first zone 115₁ not applying power to the second target 306 or by applying power at a low power level to the second target 306. In another embodiment, the power levels applied to the targets 304, 306 can be adjusted so that the relative concentration of the first element is at a minimum in the first zone 115₁, and the relative concentration of the second element is at a maximum in the first zone 115₁.

In yet another embodiment, the relative concentration of the first element and the second element deposited in the first zone 115₁ may be controlled by at least one of setting the power level provided to the first target 304 and setting the power level provided to the second target 306 at different power levels between the power levels described above, so that one or both of the relative concentrations of the first element and the second element are not at a minimum or maximum relative concentration in the first zone 115₁.

At operation 503, subsequent zones 115 of the optical device film 110 are deposited until the final zone 115₈ of the range of zones 115 is deposited. In embodiments in which the cluster tool 390 of FIG. 3B is used to form the optical device film 110, one or more of the subsequent zones 115 deposited during operation 503 can be performed in a different PVD chamber 300A-300E than the PVD chamber 300A-E used to deposit the first zone 115₁. When the cluster tool 390 includes one or more different target materials in the different PVD chambers 300A-300E, then different zones 115 including one or more different metal, metalloid, or semiconductor elements can be deposited in the different PVD chambers 300A-300E.

The deposition of the subsequent zones includes at least one of varying the power level provided to the first target 304 or varying the power level provided to the second target 306 as the different zones are deposited to form the optical device film 110. Varying these power levels can cause different relative concentrations of the elements from the targets 304, 306 to be deposited in the different zones 115 or across different locations in the same zone 115. To deposit a binary material, such as silicon oxide, the power level provided to the target including the other metal, metalloid, or semiconductor (e.g., a target including titanium) can be set to zero while power is provided to the target including the metal, metalloid, or semiconductor that is to be included in the binary material.

The optical device film 110 also includes a concentration of oxygen and/or nitrogen. In some embodiments, the optical device film 110 includes an oxygen concentration and/or nitrogen concentration that varies across the thickness 116 of the optical device film 110. In another embodiment, which can be combined with other embodiments described herein, the optical device film 110 can have a constant or substantially constant oxygen or nitrogen concentration throughout the range of zones 115 of the optical device film 110.

In some embodiments, a precursor gas can also be supplied to the process volume 305 from the precursor gas source 370 during one or more of operations 502, 503 of the method 500. In some embodiments, a precursor gas (e.g., a silicon-containing gas) is provided to the process volume instead of sputtering one of the two targets 304, 306. In another embodiment, a precursor gas is provided to the process volume 305 while both targets 304, 306 are sputtered. In some of these embodiments, the precursor gas can include a different metal, metalloid, or semiconductor element than the two targets 304, 306 being sputtered, so that three metal, metalloid, or semiconductor elements can be deposited in the optical device film 110 in addition to oxygen or nitrogen. The flow rate of precursor gas from the precursor gas source 370 can be adjusted during operation to control the relative concentration of the element from the precursor gas that is deposited in the different zones 115 of the optical device film 110.

FIG. 6 is a flow diagram of a method 600 of forming the optical device film 110 shown in FIG. 1, according to one embodiment. The optical device film 110 may be modified in subsequent processes to form the devices 200a (FIG. 2A), 200b (FIG. 2B). The method 600 can be performed using the CVD chamber 400 of FIG. 4. However, it is to be noted that a CVD chamber other than the CVD chamber 400 of FIG. 4 may be used to perform the method 600.

The method 600 begins at operation 601. At operation 601, the optical device substrate 101 is disposed on the substrate support 406 in the CVD chamber 400.

At operation 602, the first zone 115₁ of the range of zones 115 of the optical device film 110 is deposited. During operation 602, a first gas can be provided to the process volume 404 from the first gas source 416A, and a second gas can be provided to the process volume 404 from the second gas source 416B. The first gas can have a first gas flow rate that is controlled by the first flow controller 418A. The second gas can have a second gas flow rate that is controlled by the second flow controller 418B. The first gas source 416A can provide a first gas containing a metal, metalloid, or semiconductor element that is to be deposited in the optical device film 110. The second gas source 416B can provide a second gas containing a metal, metalloid, or semiconductor element that is to be deposited in the optical device film 110. In some embodiments, another gas source and flow controller (not shown) can be used to provide an oxygen-containing gas or a nitrogen-containing gas to the process volume 404.

During operation 602, the relative concentrations of a first element (e.g., silicon) and a second element (e.g., titanium) deposited into the first zone 115₁ can be controlled by controlling the flow rate of gases containing these elements from the respective gas sources 416A, 416B.

At operation 603, subsequent zones of the optical device film 110 are deposited until the final zone 115₈ of the range of zones 115 is deposited. The deposition of the subsequent zones 115 can include at least one of increasing or decreasing a first flow rate of the first gas from the first gas source 416A and increasing or decreasing a second flow rate of the second gas from the second gas source 4166 to form the optical device film 110. In one embodiment, which can be combined with other embodiments described herein, the thickness 116 has a constant or substantially constant oxygen or nitrogen concentration throughout the range of zones 115 of the optical device film 110.

In some embodiments, RF power is provided to the showerhead 414 to perform a plasma enhanced chemical vapor deposition during operations 602, 603.

In summation, optical devices that include optical device films and methods of forming optical device films for optical devices are provided. The disclosed optical device films can include two or more, such as three or more metal, metalloid, or semiconductor elements at a same or across different locations within the optical device film, which enables the refractive index to be more tightly controlled compared to when a lower number of elements are included in an optical device film. Using a higher number of elements in the films can allow for more gradual changes in the refractive index of the optical device film across the thickness of the optical device film as well as provide for more options for limiting optical loss that can occur in an optical device film. For example, two different materials, such as two different ternary materials (i.e., ternary materials that include at least one different element) can have a same or substantially similar refractive index, but the one material may cause lower optical loss for a given application when compared to the other ternary material having the same or substantially refractive index.

While the foregoing is directed to examples of the present disclosure, other and further examples of the disclosure may be devised without departing from the basic scope thereof, and the scope thereof is determined by the claims that follow.

What is claimed is:

1. An optical device comprising:
an optical device substrate having a first surface; and
a plurality of optical device structures disposed over the first surface of the optical device substrate, the plurality of optical device structures spaced apart from each other in a direction parallel to the first surface, and each optical device structure of the plurality of optical device structures including an optical device film, wherein the optical device film of each optical device structure comprises:
a first zone and a second zone, the first zone positioned between the optical device substrate and the second zone, wherein
the first zone and the second zone each include one or more of oxygen and nitrogen, and
the first zone and the second zone collectively include three or more metal, metalloid, or semiconductor elements.

2. The optical device film of claim 1, wherein
the first zone includes two metal, metalloid, or semiconductor elements, and
the second zone includes one metal, metalloid, or semiconductor element that is different than the two metal, metalloid, or semiconductor elements in first zone.

3. The optical device film of claim 1, wherein
the first zone includes two or more metal, metalloid, or semiconductor elements, and
the second zone includes two or more metal, metalloid, or semiconductor elements that are different than the two or more metal, metalloid, or semiconductor elements in first zone.

4. The optical device film of claim 3, further comprising a third zone positioned between the first zone and the second zone, wherein the third zone includes a metal, metalloid, or semiconductor element that is different than the two or more metal, metalloid, or semiconductor elements in first zone and the second zone.

5. The optical device film of claim 1, wherein
the first zone includes two or more metal, metalloid, or semiconductor elements,
the second zone includes two or more metal, metalloid, or semiconductor elements,
one metal, metalloid, or semiconductor element included in the first zone is a same element as one metal, metalloid, or semiconductor element included in the second zone, and
one metal, metalloid, or semiconductor element included in the first zone is different than one metal, metalloid, or semiconductor element included in the second zone.

6. The optical device of claim 5, further comprising a third zone positioned between the first zone and the second zone, wherein the third zone includes a metal, metalloid, or semiconductor element that is different than the two or more metal, metalloid, or semiconductor elements in first zone and the second zone.

7. The optical device of claim 5, further comprising a third zone positioned between the first zone and the second zone, wherein
the first zone comprises titanium, silicon, and oxygen,
the second zone comprises titanium, niobium, and oxygen, and
the third zone comprises silicon and oxygen.

8. The optical device film of claim 1, wherein
the first zone includes two or more metal, metalloid, or semiconductor elements,
the second zone includes the same two or more metal, metalloid, or semiconductor elements.

9. The optical device of claim 8, further comprising a third zone positioned between the first zone and the second zone, wherein the third zone includes a metal, metalloid, or semiconductor element that is different than the two or more metal, metalloid, or semiconductor elements in first zone and the second zone.

10. The optical device of claim 1, wherein at least one of the first zone and the second zone include oxygen and nitrogen.

11. The optical device of claim 1, wherein the three or more metal, metalloid, and semiconductor elements include three or more of Ti, Si, Nb, Ta, Al, In, Cr, Ru, Hf, Mg, Zr, V, Mo, W, Mn, Fe, Co, Ni, Cu, Zn, Ga, Sn, Bi, Sb, Gd, Pr, Sc, and Y.

12. A method of forming an optical device film on an optical device substrate, the method comprising:
disposing an optical device substrate on a substrate support in a process chamber; and
depositing an optical device film over the optical device substrate, wherein the optical device film comprises:
a first zone and a second zone, the first zone positioned between the optical device substrate and the second zone, wherein
the first zone and the second zone each include one or more of oxygen and nitrogen, and
the first zone and the second zone collectively include three or more metal, metalloid, or semiconductor elements.

13. The method of claim 12, wherein
the first zone includes two metal, metalloid, or semiconductor elements, and
the second zone includes one metal, metalloid, or semiconductor element that is different than the two metal, metalloid, or semiconductor elements in first zone.

14. The method of claim 12, wherein
the first zone includes two or more metal, metalloid, or semiconductor elements, and
the second zone includes two or more metal, metalloid, or semiconductor elements that are different than the two or more metal, metalloid, or semiconductor elements in first zone.

15. The method of claim 14, wherein the optical device film further comprises a third zone positioned between the first zone and the second zone, wherein the third zone includes a metal, metalloid, or semiconductor element that is different than the two or more metal, metalloid, or semiconductor elements in first zone and the second zone.

16. The method of claim 12, wherein
the first zone includes two or more metal, metalloid, or semiconductor elements,
the second zone includes two or more metal, metalloid, or semiconductor elements,
one metal, metalloid, or semiconductor element included in the first zone is a same element as one metal, metalloid, or semiconductor element included in the second zone, and
one metal, metalloid, or semiconductor element included in the first zone is different than one metal, metalloid, or semiconductor element included in the second zone.

17. The method of claim 16, wherein the optical device film further comprises a third zone positioned between the first zone and the second zone, wherein the third zone includes a metal, metalloid, or semiconductor element that is different than the two or more metal, metalloid, or semiconductor elements in first zone and the second zone.

18. The method of claim 12, wherein at least one of the first zone and the second zone includes oxygen and nitrogen.

19. The method of claim 12, wherein the three or more metal, metalloid, and semiconductor elements include three or more of Ti, Si, Nb, Ta, Al, In, Cr, Ru, Hf, Mg, Zr, V, Mo, W, Mn, Fe, Co, Ni, Cu, Zn, Ga, Sn, Bi, Sb, Gd, Pr, Sc, and Y.

20. A method of forming an optical device film on an optical device substrate, the method comprising:
disposing an optical device substrate on a substrate support in a first process chamber;
depositing a first zone of the optical device film over the optical device substrate, wherein the first zone of the optical device film comprises:
one or more of oxygen and nitrogen, and
two or more metal, metalloid, or semiconductor elements;
disposing an optical device substrate on a substrate support in a second process chamber; and
depositing a second zone of the optical device film over the first zone of the optical device film, wherein the second zone of the optical device film comprises:
one or more of oxygen and nitrogen, and
two or more metal, metalloid, or semiconductor elements, wherein the two or more metal, metalloid, or semiconductor elements included in the second zone are different than the two or more metal, metalloid, or semiconductor elements included in the second zone.
